(19) United States
(12) Patent Application Publication
(10) Pub. No.: US 2015/0086118 A1
(43) Pub. Date: Mar. 26, 2015

(54) METHOD FOR RECOGNIZING A VISUAL CONTEXT OF AN IMAGE AND CORRESPONDING DEVICE

(71) Applicant: COMMISSARIAT A L'ENERGIE ATOMIQUE ET AUX ENERGIES ALTERNATIVES, PARIS (FR)

(72) Inventors: Aymen Shabou, Clamart (FR); Herve Le Borgne, Paris (FR)

(21) Appl. No.: 14/394,254

(22) PCT Filed: Apr. 11, 2013
(86) PCT No.: PCT/EP2013/057540

§ 371 Date: Oct. 13, 2014

(30) Foreign Application Priority Data
Apr. 16, 2012 (FR) 1253495

(51) Int. Cl. G06K 9/62

(52) U.S. Cl. CPC G06K 9/6249
USPC 382/195

(57) ABSTRACT

A method for recognizing a visual context in an image includes at least one step of extracting features from the image and including at least one step of coding the plurality of local descriptors developing a coding matrix by associating each local descriptor with one or a plurality of visual words in a codebook according to at least one similarity criterion, the method being characterized in that said coding step results from a compromise between the similarity between a given local descriptor and the visual words of a codebook and its resemblance to the visual words associated with the local descriptors which are spatially near to it in the domain of the image.

The present invention relates to a method for recognizing the visual context of an image and a corresponding device therefor. The present invention falls into the domain of detection and automatic recognition of objects in images or video streams, known as the domain of semantic classification. More precisely, the present invention falls into the domain known as supervised classification. It applies notably to video surveillance, artificial vision e.g. in robots or vehicles, and image searching.

Various applications require that objects can be identified in images or in video streams. The recognition of objects in images is a major issue in the domain of artificial vision.

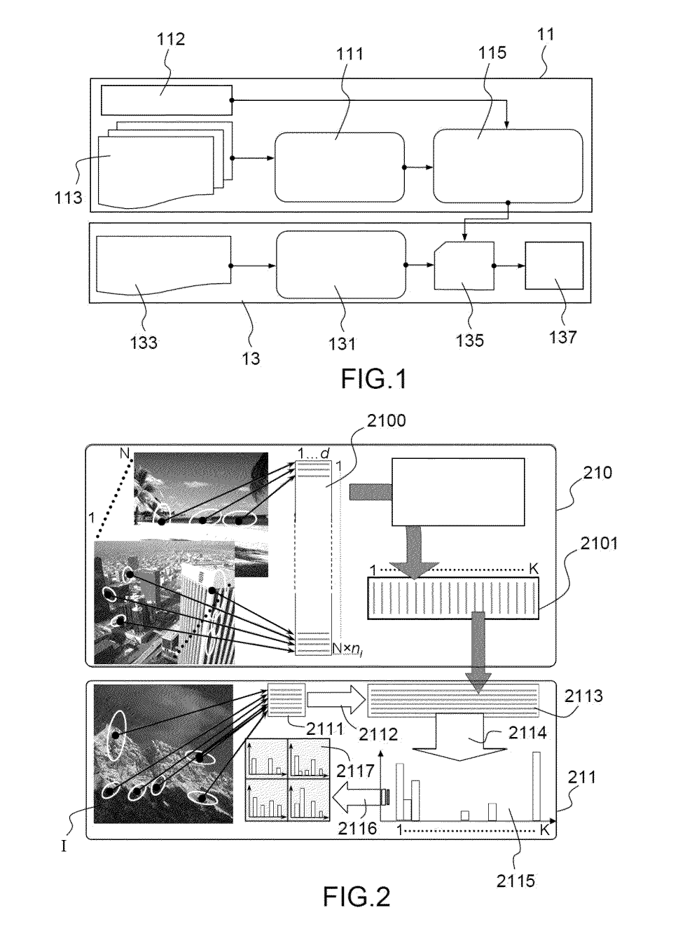

Supervised classification is a particularly suitable technique for the recognition of objects in images. Supervised classification involves two main phases: a first phase is performed offline, and constitutes a learning phase for establishing a model; a second phase, termed a test phase, is performed online and can be used to determine a prediction of a test image ‘label’. These stages are explained in greater detail below with reference to FIG. 1.

In applications covered by the present invention, it is sought to recognize a visual concept category, rather than a particular instance. For example, if the visual concept is the concept ‘automobile’, we try to recognize any automobile even if the automobile present in the image tested is not present in the learning base.

Each of the aforementioned two phases notably includes a step commonly referred to as ‘feature extraction’, aimed at describing an image or portion of an image, via a set of features forming a vector of determined dimension. The quality of feature extraction is based on the relevance and robustness of the information to be extracted from images, in the sense of the visual concepts that are to be recognized. Robustness is notably to be considered with regard to variations of the images in terms of point of view, brightness, rotation, translation and zoom.

Known feature extraction techniques involve a step of extracting local descriptors from the image, for reconstructing a final signature, via a ‘bag of visual words’ approach commonly referred to by the acronym BOV corresponding to ‘Bag Of Visual terms’ or ‘Bag Of Visterms’. FIG. 2 described in detail below illustrates the operating principle of a feature extraction step. Typically, one or a plurality of local descriptors are extracted from the image considered, from pixels or dense patches in the image, or more generally sites in the image. In other words, local descriptors are associated with as many patches, which may notably be defined by their localization or locality, e.g. by coordinates (x, y) in a Cartesian coordinate system in which the domain of the image considered is also defined, a patch being able to be limited to one pixel, or consist of a block of a plurality of pixels. In what follows the localization of local descriptors will be referred to for designating the localization of the sites with which they are associated, and spatially neighboring local descriptors in an image may be qualified in a similar way, when the sites with which they are associated are spatially neighbors in the image. The local descriptors are then recoded during a step of ‘coding’ in a ‘feature space’, according to a reference dictionary, commonly referred to by the term ‘codebook’. The recoded vectors are then aggregated, during a step of aggregating or ‘pooling’ in a unique signature forming vector. These steps may be repeated for several portions of the image considered, then the signatures concatenated, e.g. according to a spatial pyramid scheme, known by the acronym SPM for ‘Spatial Pyramid Matching’, consisting in dividing the image considered into sub-blocks, e.g. squares of 2×2 or 4×4 blocks, or rectangles of 1×3 blocks, etc., determining the signature for each sub-block then concatenating all the signatures determined by weighting them by a factor depending on the scale of the divisions into sub-blocks. An SPM type technique is, for example, described in the publication by S. Lazebnik, C. Schmid and J. Ponce, ‘Beyond bags of features: Spatial pyramid matching for recognizing natural scene categories’ in CVPR, 2006.

Various known techniques form the basis of the aforementioned steps of aggregation and coding. The coding step may notably be based on a technique known as ‘Hard Coding’ or under the corresponding acronym HC. Hard coding techniques are, for example, described in the aforementioned publication by S. Lazebnik, C. Schmid and J. Ponce, ‘Beyond bags of features: Spatial pyramid matching for recognizing natural scene categories’, or in the publication by J. Sivic and A. Zisserman ‘Video google: a text retrieval approach to object matching in videos’ in ICCV, 2003. According to a hard coding technique, a local descriptor is recoded in a vector comprising a single ‘1’ on the dimension corresponding to the index of its nearest neighbor in the codebook, and a plurality of ‘Os’ elsewhere. Associated with an aggregation step based on the determination of an average, a step of coding by hard coding thus leads to the creation of a histogram of occurrence of visual words most present in the codebook, a visual word in the codebook being considered as present when it is the nearest to a local descriptor of the image considered.

The coding step may also be based on a technique known as ‘Soft Coding’ or under the corresponding acronym SC. A soft coding technique is notably described in the publication by J. Van Gemert, C. Veenman, A. Smeulders and J. Geusebroek ‘Visual word ambiguity’—PAMI, 2009. According to the soft coding technique, a local descriptor is recoded according to its similarity to each of the visual words of the codebook. The similarity is, for example, calculated as a decreasing function of distance, typically an inverse exponential function of distance.

The coding step may also be based on a technique commonly known as ‘Locally constrained Linear Coding’ or under the corresponding acronym LLC. LLC type techniques are notably described in the publication by S. Gao, I. Tsang, L. Chia and P. Zhao, ‘Local features are not lonely—Laplacian sparse coding for image classification’ in CVPR, 2011, in the publication by L. Liu, L. Wang and X. Liu, ‘In defense of soft-assignment coding’ in CVPR, 2011, or in the publication by J. Yang, K. Yu, Y. Gong and T. Huang ‘Linear spatial pyramid matching using sparse coding for image classification’ in CVPR, 2009. The principle of this technique consists in restricting soft coding to the nearest neighbors of descriptors in the feature space, e.g. 5 to 20 nearest neighbors of the codebook. In this way, coding noise can be significantly reduced.

The coding step may also be based on a technique commonly known as ‘Locally constrained Salient Coding’ where each descriptor is only coded on its nearest neighbor by associating a response therewith, known as ‘saliency’ relevance, which depends on the relative distances of the nearest neighbors to the descriptor. In other words, the shorter the distance of the nearest neighbor to the descriptor with respect to the distances of other near neighbors to this same descriptor, the greater is the relevance. A ‘saliency coding’ type of technique is notably described in the publication by Y. Huang, K. Huang, Y. Yu, and T. Tan. ‘Salient coding for image classification’, in CVPR, 2011.

One drawback of the known methods for recognizing visual context, implementing known feature extraction steps, is linked to the fact that although local descriptors are nearby in an image, and therefore probably have similar features, their coding in the feature space by the coding step can lead to great variability. As a result relatively homogeneous wide areas of an image may be coded very differently.

One object of the present invention is to overcome at least the aforementioned drawbacks, by providing a method of recognizing a visual context of an image based on the bags of words technique, smoothing the codes of the local descriptors according to their mutual spatial proximity and their similarity.

To this end the present invention notably proposes to include a novel coding step in a method of recognition, or appropriate means for implementing it in a device for recognizing visual context, implementing, for example, a coding taking into account the spatial context of the local descriptors, enabling the selection of the non-zero dimensions of the recoded vectors and preceding a coding technique known in itself.

By considering the local descriptors as being distributed according to a predetermined structure, e.g. a regular grid, the present invention proposes that taking into account the spatial context of the local descriptors is achieved by means of an objective function, taking into account both the locality constraint in the spatial domain, i.e. that two nearby local descriptors on the grid are candidates for being coded identically according to the similarity between them, or according to the similarity of the visual words of the codebook with which neighboring local descriptors are associated, and a local coding in the feature space.

Another advantage of the invention is that it can be based on any one of the coding techniques known in themselves, examples of which have been described previously.

Accordingly, the subject matter of the invention is a method for recognizing a visual context in an image forming part of a domain, including at least one step of extracting features from the image and including at least:
a step of extracting a plurality of local descriptors for a plurality of sites of the image,
a step of coding the plurality of local descriptors developing a coding matrix by associating each local descriptor with one or a plurality of visual words of a codebook according to at least one similarity criterion,
an aggregation step forming a unique signature from the coding matrix,
   the method being characterized in that said association developed during said coding step is further performed according to the similarity between each local descriptor and the visual words of the codebook associated with at least one spatially near local descriptor in the domain of the image of each local descriptor considered.

According to one embodiment of the invention, the association performed during the coding step may be carried out by means of minimizing an objective function defined by a sum of a first term expressing the association of a given local descriptor with nearby visual words of the codebook, and a second term expressing the association of similar visual words of the codebook for the neighboring local descriptors in the image, and displaying a sufficient level of similarity between them.

According to one embodiment of the invention, said second term may be weighted by a global regularization parameter.

According to one embodiment of the invention, said objective function may be defined by the relationship (1) shown below.

According to one embodiment of the invention, the minimization of the objective function may be performed by an optimization algorithm.

According to one embodiment of the invention, said optimization algorithm may be based on a graph cuts type of approach.

A method of recognition according to one of the embodiments of the invention may be applied to recognizing a visual context in a video stream formed by a plurality of images, at least one image among the plurality of images forming the object of a method for recognizing a visual context in an image according to one of the embodiments of the invention.

The subject matter of the present invention is also a supervised classification system including at least one learning phase performed offline, and a test phase performed online, the learning phase and the test phase each including at least one feature extraction step as defined in a method of recognition according to any one of the embodiments of the invention.

The subject matter of the present invention is also a device for recognizing a visual context in an image including means suitable for implementing a method of recognition according to any one of the embodiments of the invention.

The subject matter of the present invention is also a computer program comprising instructions for implementing a method according to one of the embodiments of the invention.

Other features and advantages of the invention will become apparent on reading the description, given by way of example, with reference to the accompanying drawings in which:

FIG. 1 is a diagram illustrating the supervised classification technique;

FIG. 2 is a diagram illustrating the principle of the image feature extraction technique according to the BOV approach;

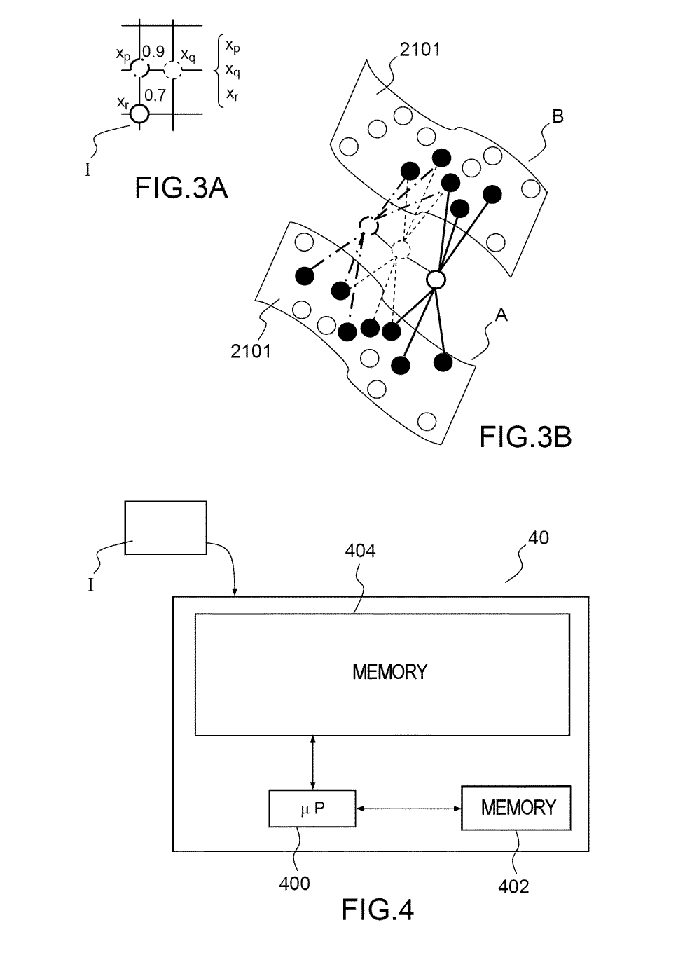

FIGS. 3a and 3b show a diagram synoptically illustrating the principle of associating local descriptors with visual words of a codebook, according to an example of embodiment of the present invention;

FIG. 4 is a diagram synoptically illustrating a device for recognizing visual context according to an example of embodiment of the present invention.

FIG. 1 shows a diagram illustrating the supervised classification technique, previously introduced.

A supervised classification system notably includes a learning phase 11 performed offline, and a test phase 13 performed online.

The learning phase 11 and the test phase 13 each include a feature extraction step 111, 131 for describing an image by a vector of determined dimension. The learning step 11 consists in extracting the features on a large number of learning images 113; a series of signatures and corresponding labels 112 supply a learning module 115, which then produces a model 135.

The test step 13 consists in describing, by means of the feature extraction step 131, a ‘test image’ 133 via a vector of the same nature as during the learning phase 11. This vector is applied to the input of the aforementioned model 135. The model 135 produces at its output a prediction 137 of the test image 133 label. The prediction associates the most relevant label (or labels) with the test image from among the set of possible labels.

This relevance is calculated by means of a decision function associated with the learning model learned on the learning base depending on the learning algorithm used.

The label of an image indicates its degree of belonging to each of the visual concepts considered. For example, if three classes are considered, e.g. the classes ‘beach’, ‘town’ and ‘mountain’, the label is a three-dimensional vector, of which each component is a real number. For example, each component can be a real number between 0 if the image does not contain the concept, and 1 if the image contains the concept with certainty.

The learning technique may be based on a technique known in itself, such as the technique of wide margin separators, commonly referred to by the acronym SVM for ‘Support Vector Machine’, on a technique known as ‘boosting’, or on a technique of the type referred to by the acronym MKL for ‘Multiple Kernel Learning’.

The present invention more particularly relates to the feature extraction step 111, 131, and is therefore integrated into a method for recognizing visual context further notably comprising a step for acquiring an image or a video stream, an optional step of dividing the image into sub-images, the prediction of the label for the test image or a sub-image.

FIG. 2 shows a diagram illustrating the principle of the image feature extraction technique.

A step of feature extraction 211 from an image I includes a step of extracting a plurality n of local descriptors 2111 for a plurality of patches of the image I. The local descriptors 2111 are vectors of size d. The extraction of local descriptors may be performed according to various techniques known in themselves. For example, according to the ‘Scale-Invariant Feature Transform’, commonly referred to by the corresponding acronym ‘SIFT’, or according to the ‘Histograms Of Gradients’ technique, commonly referred to by the corresponding acronym HOG, or according to the ‘Speeded Up Robust Features’ technique, commonly referred to by the acronym SURF.

A local descriptor involves a mathematical or statistical transformation from at least one pixel of an image. Examples of local descriptors, well known to the person skilled in the art, will be found in the articles ‘Mikolajczyk K.; Schmid, C., “A performance evaluation of local descriptors”, Pattern Analysis and Machine Intelligence, IEEE Transactions on, Vol. 27, no. 10, pp. 1615, 1630, October 2005, doi: 10.1109/TPAMI.2005.188’ or in the sections ‘localization of features’ and ‘local features’ in the article http://fr.wikidedia.org/wiki/Extraction_de_caract%C3%A9risique_en_vision_par_ordinateur [Computer vision feature extraction].

In particular, a local descriptor is not a simple image region obtained by segmentation.

The n local descriptors 2111 are recoded in the feature space during a coding step 2112 for forming a coding matrix 2113, according to a codebook 2101 and at least one similarity criterion, the codebook 2101 being constructed during a development phase 210 of the codebook described in detail below. The codebook 2101 includes a plurality K of visual words of size d, and its size is therefore equal to d×K (d rows and K columns). The recoded vectors forming the coding matrix 2113 are then aggregated during an aggregation step 2114 or ‘pooling’ step for forming a unique vector or signature 2115 of length K. The process defined by the coding 2112 and aggregation 2114 steps is optionally repeated for multiple portions of the image I or sub-images, then the signatures concatenated during a step of concatenation 2116 for forming a concatenated signature 2117 according to a spatial pyramid type scheme.

The codebook 2101 is established during the development phase 210 from a large collection of local descriptors originating from a plurality of images 1 to N. For a number nᵢ of local descriptors per image 1 to N, a matrix 2100 of N×nᵢ local descriptors of size d is constructed. The codebook 2101 can then, for example, be constructed from the matrix 2100 using an unsupervised classification, referred to by the term ‘clustering’, e.g. according to the K-means algorithm, for partitioning the N×nᵢ local descriptors into a plurality k of sets in order to minimize the reconstruction error of the descriptors through the centroid inside each partition. It is also possible to use other methods of codebook learning, such as, for example, the random drawing of local descriptors or sparse coding.

The aggregation step 2114 may, for example, consist in performing an average, or the aggregation may be carried out according to the maximum per column of the coding matrix 2113 of dimension n×K.

The coding step 2112 may in part be based on a coding technique such as the hard coding technique, or soft coding technique, or locally constrained linear coding or LLC, or salient coding LSC, these techniques known in themselves being previously introduced.

Based on a Markov assumption for a given image I, it can be asserted that neighboring patches in an even or smooth area of the image must be coded on similar bases from the codebook 2101. On the other hand, for neighboring patches in an area of the image I displaying discontinuities, the corresponding bases in the codebook 2101 may vary, according to the information from the corresponding local descriptors.

Let P={1; 2; . . . ; N₁} the set of indices of the pixels or dense patches, or more generally the sites, in the image I. A set of local descriptors X={xₚ; xₚε [symbol] ^{d}; pεP} is extracted from the image I for all the sites considered.

The codebook 2101 may be denoted by B={bᵢ; bᵢε [symbol] ^{K}; iε [symbol] }. It is considered that each local descriptor is assigned to a subset of local reference vectors or ‘visual words’ belonging to the codebook 2101.

For simplicity of notation, it is possible to use Y={yₚ; yₚε [symbol] ^{m}; pεP} to denote the set of indices of the local reference vectors with which the local descriptors xₚ are associated.

In the example case where the coding step is based in part on a locally constrained linear coding or LLC, each vector yₚ represents the indices of the m nearest visual words to xₚ.

The set of local reference vectors relating to the indices in the vector yₚ may be denoted by \hat{B}ₚ={\hat{b}_{p,i}; iε{1; . . . ; m}} and it is possible to define the set \hat{B} of the sets \hat{B}ₚ, that is: \hat{B}={\hat{B}ₚ; pεP}.

Thus, according to a ‘locality’ assumption, each local descriptor may be associated with visual words included in the set of k nearest visual words of the codebook 2101, k being greater than m. The number k restricts the search for the m optimal vectors of the codebook to a local neighborhood in the local descriptor space in order take into account the locality assumption in the local descriptor space and accelerate the process of searching the optimal base for a given local descriptor.

In other words, k designates the maximum number of vectors of the base of which m vectors will be considered as the optimal ones for coding a given local descriptor.

The value of k may be chosen sufficiently large so as to consider a relatively wide neighborhood in the feature space.

The set of indices of the k visual words nearest to the local descriptor xₚ may be denoted by: Lₚ={lₚ¹; lₚ²; . . . ; lₚ^{k}}

This set may be designated as a set of all the labels that a site p may possibly assume.

The problem addressed by the present invention can be likened to a labeling problem consisting in determining the optimal reference or ‘association’ for each local descriptor, among the k nearest visual words, according to the spatial context assumption.

It is possible for this purpose to introduce an objective function, or ‘energy function’ E(Y) for formalizing this problem, put in the form of a sum of a first term expressing the association of a given local descriptor with nearby visual words of the codebook, and a second term expressing the association of similar visual words of the codebook for spatially near local descriptors in the image I, and displaying a sufficient similarity between them.

Advantageously a global regularization parameter can be used to weight the second term with respect to the first term, so that the smoothing enabled by this invention can be adjusted.

FIGS. 3a and 3b synoptically illustrate the principle of associating local descriptors with visual words of the codebook, according to an example of embodiment of the present invention.

With reference to FIG. 3a, three local descriptors xₚ, x_{q} and xᵣ can be extracted from three sites of an image I. The image I can be subdivided into a regular grid, in the example illustrated by the figure. The local descriptors xₚ, x_{q} and xᵣ are neighbors within the context of the regular grid. The first local descriptor xₚ has a first degree of similarity, equal to 0.9 in the example illustrated by the figure, with the second local descriptor x_{q}, and a second degree of similarity, equal to 0.7 in the example illustrated by the figure, with the third local descriptor xᵣ.

It should be observed that the use of a regular grid constitutes only one non-restrictive example of the present invention. Other image segmentation techniques may be used. For example, preliminary processing can be used to elect sites arranged at particular points of the image according to various criteria such as contrast gradients, etc.

Now with reference to FIG. 3b, the local descriptors xₚ, x_{q} and xᵣ are associated, during the coding step, with visual words of the codebook 2101. The same codebook is illustrated in the figure by two references A and B: the first reference A illustrates a principle of association according to a coding technique known in the art, e.g. one of the known coding techniques previously introduced; the second reference B illustrates a principle of association according to an example of embodiment of the present invention.

According to one of the known prior art coding techniques, the three local descriptors xₚ, x_{q} and xᵣ are each associated with a plurality of the nearest neighbors among the visual words of the codebook 2101, three in number in the example illustrated by the figure. The association of a local descriptor with visual words of the codebook 2101 is performed according to similarity criteria, i.e. distance. The three local descriptors xₚ, x_{q} and xᵣ are thus associated with visual words of the codebook regardless of spatial proximity in the image I of the sites from which they originate. Thus, local descriptors which are spatially neighboring in the image and similar, such as the first and second local descriptors xₚ, x_{q} may be associated with different visual words of the codebook 2101. In the example illustrated by the figure, the first local descriptor xₚ and the second local descriptor x_{q} share only one visual word of the codebook 2101, despite their spatial neighborhood and their similarity.

Now considering the second reference B in FIG. 3b, the principle of association according to the present invention ensures that local descriptors originating from spatially neighboring sites of the image I, and displaying a sufficient degree of similarity, are associated with identical visual words of the codebook 2101. In the example illustrated by FIG. 3b, the first local descriptor xₚ and the second local descriptor x_{q} thus share three common visual words of the codebook 2101.

Thus, according to the present invention, the coding step 2112 can develop the coding matrix 2113 by associating each local descriptor with one or a plurality of visual words of a codebook 2101 according to at least one similarity criterion, the association being further performed according to the similarity between each local descriptor 2111 and the visual words of the codebook 2101 associated with at least one spatially near local descriptor 2111 in the domain of the image I of each local descriptor 2111 considered.

It is, for example, possible to introduce an energy function synthesizing the principle of association described above, and which can be formulated by the following relationship:

$$E ( Y ) = \underbrace{{\sum }_{p ∈ P}^{ } {f}_{data} ( {x}_{p} , {\hat{B}}_{p} )}_{{E}_{p} ( {y}_{p} )} + β \underbrace{{\sum }_{p ∼ q}^{ } {w}_{p , q} {f}_{prior} ( {\hat{B}}_{p} , {\hat{B}}_{q} )}_{{E}_{p , q} ( {y}_{p} , {y}_{q} )} , \qquad ( 1 )$$

where:
the term f_{data}(xₚ,\hat{B}ₚ) represents the total distance between a local descriptor xₚ and a selected plurality of m reference visual words, that is f_{data}(xₚ,\hat{B}ₚ)=Σᵢ₌₁^{m}∥xₚ−\hat{b}_{p,i}∥₂²;
p˜q represents the indices of two spatially neighboring local descriptors according to a determined neighborhood system, the neighborhood system being able, for example, to be defined by a grid of the four nearest neighbors;
the term fₚᵣᵢₒᵣ(\hat{B}ₚ,\hat{B}_{q}) represents a sum of the distances between the visual words associated with the neighboring local descriptors xₚ and x_{q}, that is fₚᵣᵢₒᵣ(\hat{B}ₚ,\hat{B}_{q})=Σᵢ₌₁^{m}∥\hat{b}_{p,i}−\hat{b}_{q,i}∥;
the term w_{p,q} represents a local ‘regularization’ parameter corresponding to the level of similarity between the local patches xₚ and x_{q}. Thus, the higher the level of similarity that the local patches have, the more the reference selection operation is regularized. Various methods of measuring similarity between local features may be employed. It is, for example, possible to use a ‘histogram intersection kernel’ technique, particularly effective when the local features are based on histograms. This technique consists in measuring the similarity between two histogram vectors by summing the minimum values between the two vectors in each dimension. A histogram intersection kernel can be denoted by K(•,•). The local regularization parameters can be established according to the following relationship:

$${w}_{p , q} = \{ \begin{matrix}K ( {x}_{p} , {x}_{q} ) & if K ( {x}_{p} , {x}_{q} ) \geq T , \\ 0 & else\end{matrix} . \qquad ( 2 )$$

This binary form of the regularization parameters enables a regularization only on similar neighboring patches, below a similarity threshold value denoted by T. Furthermore, it reduces the sensitivity of the model to the global regularization parameter β. The global regularization parameter can be used to adjust the influence of smoothing.
The relationship (1) above includes two main terms denoted by E_{data} and Eₚᵣᵢₒᵣ. The first term E_{data} is a ‘probability’ term, penalizing the association of visual words distant from the local descriptors with the latter, whereas the second term Eₚᵣᵢₒᵣ is an ‘a priori’ term penalizing the association of different visual words with similar neighboring patches.

By minimizing the objective function defined by the relationship (1) above, it is then possible to obtain an optimal configuration of association of local descriptors with visual words of the codebook. This minimization is expressed by the following relationship:

\tilde{Y}=argminE(Y|X,\hat{B},W) (3).

The adopted associations constitute the optimal configuration that associates the optimal reference vectors with the local descriptors of the image.

It should be noted that particular cases of the objective function thus defined correspond to cases of coding techniques known in themselves, notably:
in the particular case where the global regularization parameter β is zero and where m is equal to 1, the association technique used is then the hard coding or salient coding technique;
in the particular case where the global regularization parameter β is zero and where m is greater than 1, the association technique is then an LLC type technique.

The objective function thus defined is non-convex for the general forms of the distance functions fₚᵣᵢₒᵣ and f_{data} introduced above. Its minimization can be performed appropriately, e.g. based on techniques derived from techniques known in themselves for rapid optimization usually dedicated to energy functions of the 1st order multi-label Markov random field type, i.e. involving the maximum of interaction pairs between neighboring sites, commonly referred to as ‘pairwise multi-label MRF energies’. More particularly, algorithms based on a ‘graph cuts’ approach can be used to address many labeling problems in the domain of computer vision.

For example, the algorithm known as ‘alpha-expansion’ is an algorithm based on a graph cuts approach particularly appropriate for the present application. This algorithm is an iterative algorithm based on the binary transitions of the desired configuration. At a given iteration i, each site may keep its current label or change label, changing to a new label α⁽ⁱ⁾εL, L being a discrete set of labels. This ‘binary movement’ is performed optimally by drawing up an appropriate graph in which a minimum cut/maximum flow are calculated. The binary partitions undergo several movements—or changes—of partitions until a convergence to a local energy optimum is reached. In this way, it is possible to obtain local optima of non-convex energy functions, or even a global optimum of a non-convex energy function, with good accuracy. In addition, such an algorithm has not only the advantage of being effective, but also that of being applicable to various labeling problems, even when the labels are not ordered.

Advantageously, the present invention proposes to solve the stated problem of optimization by means of a new optimization algorithm by approximation extending the principle of alpha-expansion in two directions: first so as to apply to vector labels, i.e. a finite set of labels is associated with each site; secondly for constraining each site to take on a label from an appropriate subset of labels.

This new algorithm may be designated αₖₙₙ-expansion. The principle on which this optimization algorithm is based consists in performing, at each iteration, a binary expansion movement toward α={α₁, α₂, . . . , αₘ}ε [symbol] ^{m}, only for a subset of sites S_{α}⊂P, a being included in the set of indices of k nearest visual words, that is: S_{α}={pεP, such that α⊂Lₚ}. These sites are referred to hereafter as active sites.

At each iteration of the optimization algorithm, a global binary movement of all the active sites is performed. The binary movements are iterated for a number of vector labels {α₁, α₂, . . . , αₙ} within a cycle. If the energy function continues to decrease, a new cycle is initiated, until the algorithm converges to an optimum.

The steps of the algorithm are defined below:
The input data are: Y⁽⁰⁾, the initial configuration, e.g. corresponding to an association on the basis of m nearest neighbors as used in an approach based on an LLC type coding technique; Cₘₐₓ, a value corresponding to a maximum number of cycles; W the matrix of the regularization parameters w_{p,q} previously introduced; \hat{B}, set previously introduced; X, also previously introduced.
For each cycle c≦Cₘₐₓ, proceed to the following steps:
   Select n vectors of labels {αᵢ}ᵢ₌₁ⁿ among the set of indices of the k nearest neighbors of the local descriptors;
   For each iteration i≦n, perform the following sub-steps:
      Perform an optimal binary expansion movement toward αᵢ: Y⁽ⁱ⁾=arg min E(Y|X, \hat{B}, W), such that: yₚ⁽ⁱ⁾ε{yₚ⁽ⁱ⁻¹⁾,αᵢ}, ∀pεP;
         Assign to \tilde{Y} the value y^{(I)};
   If E(\tilde{Y})<E(Y^{(c-1)}), then assign to Y(c) the value \tilde{Y}, else return the value \tilde{Y}, output datum of the algorithm.

In order to perform an optimal binary expansion movement in the sub-step described above, a directed graph G_{α}=(A_{α},ε_{α}) may be developed, A_{α} designating the set of nodes relating to the active sites, ε_{α} designating the set of oriented edges connecting neighboring nodes.

Two auxiliary nodes s and t are added for calculating the maximum flow.

When the directed graph has thus been developed, the maximum flow can be calculated in polynomial time thanks to the property of submodularity of the proposed objective function, which is a mathematical property of the function to be minimized necessary for the optimization thereof in polynomial time. Indeed, for the binary expansion movements, the constraint of submodularity on the energy function holds for all the data terms and the a priori metric terms. This is the case for the objective function according to the present invention formulated by the relationship (1) above, wherein a metric is used as an a priori for calculating the distance between the references associated with the neighboring local patches.

The minimization of this objective function on the basis of the proposed algorithm is fast, since the binary expansion movements are restricted to the active sites at each iteration; furthermore the use of a polynomial-time maximum flow algorithm as described above offers the advantage of being well suited to graphs with a grid structure.

Once the optimal base in terms of locality in the feature space and in the spatial domain of the image has been selected, i.e. once the base vectors of each descriptor have been optimally selected, according to the model established above with regard to the aforementioned coding and aggregation steps, the association of a coding or ‘response’ with each of the base vectors can be performed by means of various techniques.

For example, hard coding techniques providing ‘hard responses’, or salient coding techniques providing salient responses, or soft coding techniques providing soft responses can be used, either by solving the linear system or by calculating the a posteriori probabilities of a local feature belonging to a set of selected visual words.

For each image, the final codes are aggregated for producing a unique signature forming vector. For example, a maximum aggregation technique, commonly referred to as ‘max-pooling’ can be used, this technique offering the advantage of producing better results than an average aggregation technique, while being faster with regard to calculation time.

FIG. 4 shows a diagram synoptically illustrating a device for recognizing visual context according to an example of embodiment of the present invention.

A device for recognizing visual context of an image may be implemented by dedicated calculation means, or via software instructions executed by a microprocessor connected to a data memory. For the sake of clarity of the disclosure, the example illustrated in FIG. 4 describes the recognition device in a non-restrictive way in terms of software modules, assuming that some modules described may be subdivided into several modules, or grouped together.

The recognition device 40 receives as input a digital image I, e.g. input by input means arranged upstream, not shown in the figure. A microprocessor 400 connected to a data memory 402 enables the implementation of software modules the software instructions whereof are stored in the data memory 402 or a dedicated memory. The images, the descriptors can be stored in a memory 404 forming a database.

The device for recognizing visual context can be configured for implementing a method of recognition according to one of the embodiments described.

The implementation of a method of recognition may be achieved by means of a computer program comprising instructions provided for this purpose.

It should be noted that the present invention may also be applied to the recognition of visual context in a video stream, a method according to one of the embodiments described being able to be applied to images extracted from the video stream.

It should also be noted that the present invention may relate to all applications including the recognition of visual context. In particular, a method or a device according to the present invention may enable:
the installation of a network of video surveillance cameras on a large scale;
automatically recognizing the context of a vehicle in order to draw the consequences therefrom for subsequent processing, e.g. adapting speed when the vehicle enters an urban area;
a companion robot, or a home help robot, to recognize the room in which it is located;
recognizing a manufactured object, a logo, a place or a given atmosphere in a video or televisual stream.

1. A method for recognizing a visual context in an image forming part of a domain, including at least one step of extracting features from the image and including at least:
a step of extracting a plurality of local descriptors for a plurality of sites of the image,
a step of coding the plurality of local descriptors developing a coding matrix by associating each local descriptor with one or a plurality of visual words of a codebook according to at least one similarity criterion,
an aggregation step forming a unique signature from the coding matrix,
wherein said association developed during said coding step is further performed according to the similarity between each local descriptor and the visual words of the codebook associated with at least one spatially near local descriptor, in the domain of the image, of each local descriptor considered.

2. The method of recognition of claim 1, wherein the association performed during the coding step is carried out by means of minimizing an objective function defined by a sum of a first term expressing the association of a given local descriptor with nearby visual words of the codebook, and a second term expressing the association of similar visual words of the codebook for the neighboring local descriptors in the image, and displaying a sufficient level of similarity between them.

3. The method of recognition of claim 2 wherein said second term is weighted by a global regularization parameter.

4. The method of recognition of claim 3, wherein said objective function is defined by the following relationship:
$$E ( Y ) = \underbrace{{\sum }_{p ∈ P}^{ } {f}_{data} ( {x}_{p} , {\hat{B}}_{p} )}_{{E}_{p} ( {y}_{p} )} + β \underbrace{{\sum }_{p ∼ q}^{ } {w}_{p , q} {f}_{prior} ( {\hat{B}}_{p} , {\hat{B}}_{q} )}_{{E}_{p , q} ( {y}_{p} , {y}_{q} )} ,$$
where the term f_{data}(xₚ,\hat{B}ₚ) represents the total distance between a local descriptor xp and a plurality of visual words of the codebook, the term fₚᵣᵢₒᵣ(\hat{B}ₚ,\hat{B}_{q}) represents a sum of the distances between the visual words associated with the neighboring local descriptors xp and xq, the term p˜q represents the indices of two spatially neighboring patches according to a determined neighborhood system, Y={yₚ;yₚε [symbol] ^{m};pεP} represents the set of indices of the reference visual words with which the local descriptors xₚ are associated, the term \hat{B}ₚ={\hat{b}_{p,i};iε{1; . . . ; m}} designating the set of reference local vectors relating to the indices in the vector yₚ.

5. The method of recognition of claim 4, wherein the minimization of the objective function is performed by an optimization algorithm.

6. The method of recognition of claim 5, wherein said optimization algorithm is based on a graph cuts type of approach.

7. A method for recognizing a visual context in a video stream formed by a plurality of images, wherein at least one image among the plurality of images forms the object of a method of recognition according to claim 1.

8. A supervised classification system including at least one learning phase performed offline, and a test phase performed online, the learning phase and the test phase each including at least one feature extraction step as defined in a method of recognition as claimed in claim 1.

9. A device for recognizing a visual context in an image including suitable processor configured for implementing a method of recognition as claimed in claim 1.

10. A computer program comprising instructions for executing the method of recognition as claimed in claim 1, when the program is executed by a processor.

11. A recording medium readable by a processor on which a program is recorded comprising instructions for executing the method of recognition as claimed in claim 1, when the program is executed by a processor.
